(19) United States
(12) Patent Application Publication
(10) Pub. No.: US 2014/0201629 A1
(43) Pub. Date: Jul. 17, 2014

(54) COLLABORATIVE LEARNING THROUGH USER GENERATED KNOWLEDGE

(71) Applicant: MICROSOFT CORPORATION, Redmond, WA (US)

(72) Inventor: Larry Heck, Los Altos, CA (US)

(73) Assignee: MICROSOFT CORPORATION, Redmond, WA (US)

(21) Appl. No.: 13/743,511

(22) Filed: Jan. 17, 2013

(51) Int. Cl. G06F 3/048

(52) U.S. Cl. CPC G06F 3/048
USPC 715/708

(57) ABSTRACT

A feedback loop is used by a central knowledge manager to obtain information from different users and deliver learned information to other users. Each user utilizes a personal assistant that learns from the user over time. The user may teach their personal assistant new knowledge through a natural user interface (NUI) and/or some other interface. For example, a combination of a natural language dialog and other non-verbal modalities of expressing intent (gestures, touch, gaze, images/videos, spoken prosody, . . . ) may be used to interact with the personal assistant. As knowledge is learned, each personal assistant sends the newly learned knowledge back to the knowledge manager. The knowledge obtained from the personal assistants is combined to form a collective intelligence. This collective intelligence is then transferred back to each of the individual personal assistants. In this way, the knowledge of one personal assistant benefits the other personal assistants through the feedback loop.

### BACKGROUND

Artificial Intelligence (AI) systems have a limited scope/breadth of knowledge. Designing and training computing machines used in the AI systems require a large amount of human effort. Generally, increasing the depth of knowledge of a particular domain/task reduces the breadth of knowledge across many domains/tasks. Conversely, increasing the breadth of knowledge across many domains/tasks decreases the depth of knowledge of a particular domain/task. Today, many AI systems sacrifice the breadth of knowledge is often sacrificed in favor of depth of knowledge in a limited number of domains. Scaling the intelligence of these AI systems is challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A feedback loop is used by a central knowledge manager to obtain information from different users and deliver learned information to other users. Each user utilizes a personal assistant that learns from the user over time. The user may teach their personal assistant new knowledge (e.g. a task) through a natural user interface (NUI) and/or some other interface. For example, a combination of a natural language dialog and other non-verbal modalities of expressing intent (gestures, touch, gaze, images/videos, spoken prosody, etc.) may be used to interact with the personal assistant. As knowledge is learned, each personal assistant sends the newly learned knowledge back to the knowledge manager. The knowledge obtained from the different personal assistants is combined to form a collective intelligence. This collective intelligence is then transferred back to each of the individual personal assistants. In this way, the knowledge of one personal assistant benefits the other personal assistants through the feedback loop.

### BRIEF DESCRIPTION OF THE DRAWINGS

FIG. 1 shows a system for collaborative learning using personal assistants that learn from different users;

FIGS. 2 shows a process for interaction with a personal assistant and a central knowledge base;

FIG. 3 shows a process for learning and storing information obtained using a personal assistant;

FIG. 4 illustrates an exemplary system for collaborative learning using information learned from different users and personal assistants in a multimodal system;

FIGS. 5-7 and the associated descriptions provide a discussion of a variety of operating environments in which embodiments of the invention may be practiced; and

FIG. 8 illustrates an intent detector and an intent model.

### DETAILED DESCRIPTION

Referring now to the drawings, in which like numerals represent like elements, various embodiment will be described.

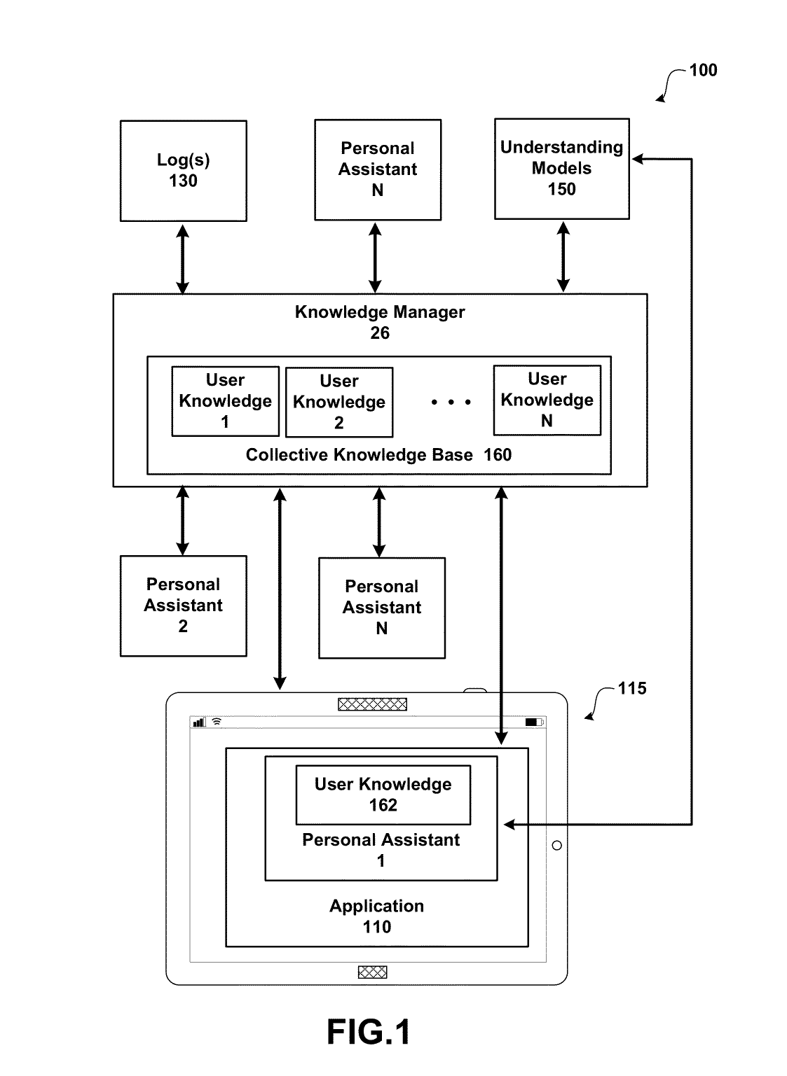

FIG. 1 shows a system for collaborative learning using personal assistants that learn from different users. As illustrated, system 100 includes knowledge manager 26, collective user knowledge 160, personal assistants 1-N, log(s) 130, understanding model(s) 150, application 110 and touch screen input device/display 115.

In order to facilitate communication with the knowledge manager 26, one or more callback routines, may be implemented. According to one embodiment, application program 110 is a multimodal application that is configured to receive speech input and input from a touch-sensitive input device 115 and/or other input devices. For example, voice input, keyboard input (e.g. a physical keyboard and/or SIP), video based input, and the like. Application program 110 may also provide multimodal output (e.g. speech, graphics, vibrations, sounds, . . . ). Knowledge manager 26 may provide information to/from application 110 in response to user input (e.g. speech/gesture). For example, a user may say a phrase to identify a task to perform by application 110 (e.g. selecting a movie, buying an item, identifying a product, . . . ). Gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device/display 115 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

A feedback loop is used by knowledge manager 26 to obtain information from different users obtained through personal assistants (e.g. personal assistants 1-N) and then deliver the learned information to other personal assistants that are associated with different users and do not yet include the newly learned information. Each user utilizes a personal assistant that learns from the user over time. For example, a user using device 115 (and/or other devices) may be associated with personal assistant 1, a different user with personal assistant 2, and a different user with different personal assistants.

A user may teach their personal assistant new knowledge through a natural user interface (NUI) and/or some other interface. For example, a combination of a natural language dialog and other non-verbal modalities of expressing intent (gestures, touch, gaze, images/videos, spoken prosody, etc.) may be used to interact with the personal assistant. Knowledge manager 26 and the personals assistants may use an understanding model (e.g. a Spoken Language Understanding (SLU) model and/or multimodal understanding model such as understanding models 150) that are used when interacting with the personal assistants and/or other applications.

As knowledge is learned by a personal assistant, the personal assistant sends the newly learned knowledge back to the knowledge manager 26. Knowledge manager 26 combines the learned information into a centralized collective knowledge base (KB) 160. The knowledge obtained from the different personal assistants is combined in the centralized KB to form a collective intelligence for the different users that are associated with KB 160. This collective intelligence is then transferred back to each of the individual personal assistant machines. In this way, the knowledge of one personal assistant benefits the other personal assistants through the feedback loop.

Knowledge manager 26 may incorporate learned knowledge (e.g. from personal assistants) into understanding model(s) 150 that is then used when receiving input and delivering responses (e.g. spoken/non spoken) as well as displayed output in the system. More details are provided below.

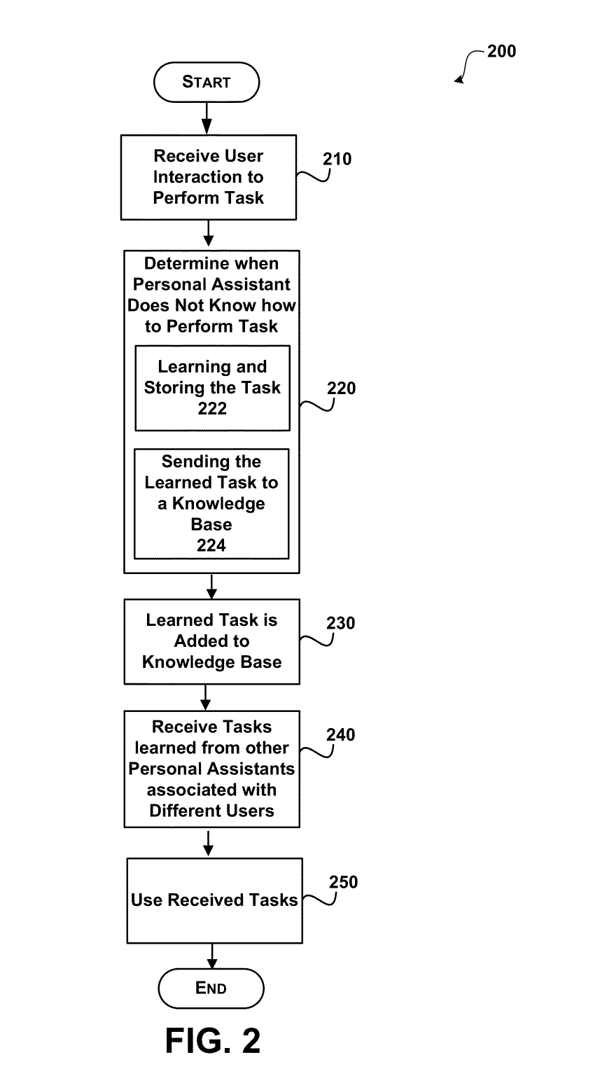

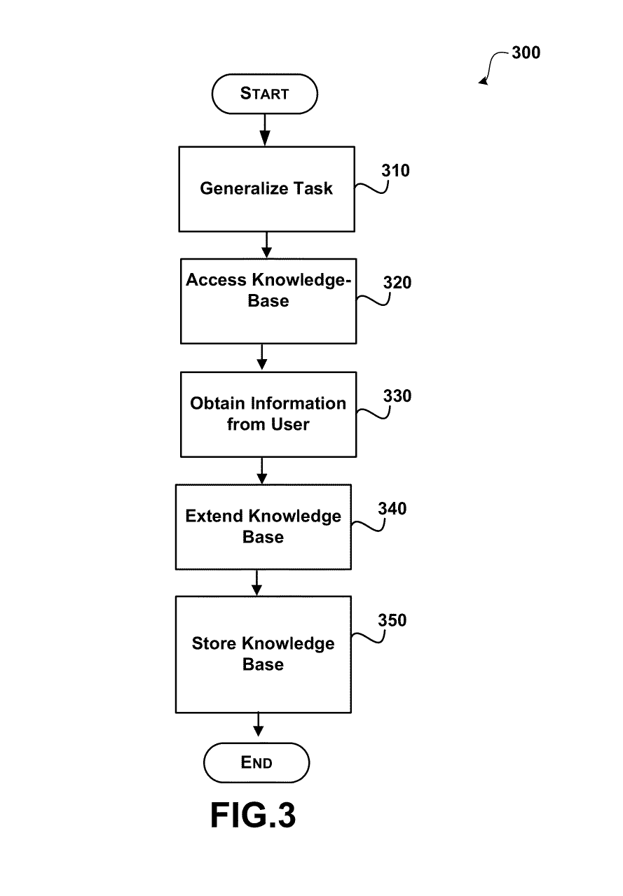

FIGS. 2 and 3 shows illustrative processes (200, 300) for collaborative learning through user generated knowledge. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof

FIG. 2 shows a process 200 for interaction with a personal assistant and a central knowledge base.

After a start operation, the process moves to operation 210, where a user interaction to perform a task is received. The user interaction is directed at performing a task (e.g. performing some action/set of actions) by a personal assistant that is associated with a user. A natural user interface (NUI) and/or some other interface is used to receive user interactions. For example, a combination of a natural language dialog and other non-verbal modalities of expressing intent (gestures, touch, gaze, images/videos, spoken prosody, printed text input, handwritten text, etc.) may be used to interact with a personal assistant. A spoken dialog system with an understanding model may also be used to interact with the personal assistant application.

Flowing to operation 220, a determination is made as to whether the personal assistant knows how to perform the task and when the personal assistant does not know how to perform the task. For example, a personal assistant may have already learned how to perform a task. The personal assistant determines when the user is referring to knowledge it does not have, such as understanding how to complete a task, or understanding that a specific intent of the user is not yet part of the personal assistant's knowledge.

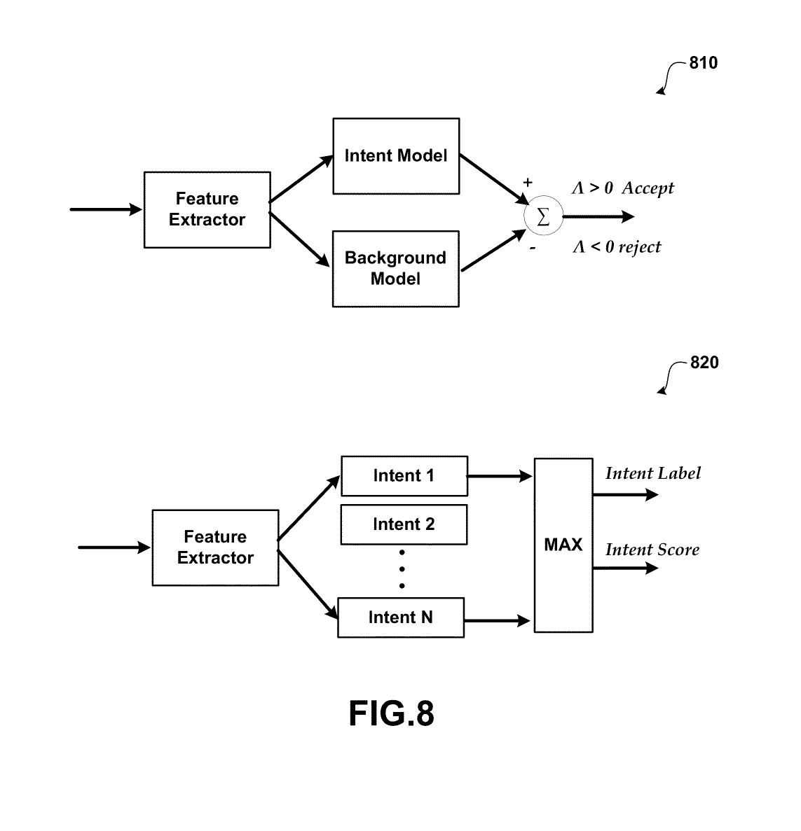

According to an embodiment, to determine unknown knowledge (e.g. unknown intent) a likelihood ratio detector is used (See FIG. 8). The Intent Model illustrated in FIG. 8 represents the known intents to the personal assistants and central knowledge base and are machine learned statistical models. The Background Model illustrated in FIG. 8 represents the unknown intents. The unknown knowledge by the personal assistant may be of various types such as entities/slots, relations between entities/slots, intents, concepts, domains, task models, and the like.

When the personal assistant does not know how to perform the task, the process moves to operation 222. When the personal assistant knows how to perform the task, the task is performed and the process moves to an end block.

At operation 222, the personal assistant learns the task. When the personal assistant does not know how to perform the task, the personal assistant receives this information from the user. According to an embodiment, a dialog interaction with the user is initiated to add this new knowledge (e.g. a new task) to its knowledge base. For example, the user says “Buy me tickets to the Harry Potter movie” to the personal assistant. The personal assistant recognizes that it does not have the intent “buy movie tickets.” The personal assistant does, however, understand the domain and concept of movie, and the action to “buy.” With this understanding, the personal assistant responds “I don't know how to buy tickets to a movie. Please show me?”. The information may be learned through recording a user's actions to perform a task and/or through other modalities (e.g. speech, gestures, . . . ). The learned information (e.g. task) may be stored using different methods. According to an embodiment, a knowledge-base (e.g. FREEBASE, DBpedia, and the like) is obtained and then extended with knowledge obtained from the user that is interacting with the personal assistant. The graph is extended by adding new nodes and edges that connect these nodes to existing nodes. These extensions represent the new knowledge learned. The extensions to the knowledge-base can be learned implicitly or explicitly (See FIG. 3 and related discussion for more information).

At operation 224, the learned information (e.g. task) is sent to the central knowledge base by the personal assistant. According to an embodiment, the nodes of the graph that were added to the knowledge-base are sent to a knowledge manager.

Moving to operation 230, the learned information is added to the central knowledge base. The central knowledge base includes the information learned from each of the different personal assistants that are each associated with a different user and/or different computing device. According to an embodiment, the nodes received from the personal assistant are incorporated into the knowledge-base.

Transitioning to operation 240, the newly learned information from one of the personal assistants is shared with other personal assistants. All/portion of the personal assistants may receive the new information. For example, when personal assistants are associated with employees of a business, the learned information from one employee may be sent to the other employees of the business. Instead of sending the learned information to each of the employees of the business, the information may be delivered based on determined criteria (e.g. part of a team, division, and the like).

Flowing to operation 250, the obtained information from the central manager are incorporated by each of the personal assistants that receive the information. In this way, information learned from another personal assistant may be utilized by other personal assistants.

The process then moves to an end operation and returns to processing other actions.

FIG. 3 shows a process 300 for learning and storing information obtained using a personal assistant.

After a start operation, the process moves to operation 310, where the task to learn is generalized based on information that is already known by the personal assistant. For example, in the example presented above, the personal assistant recognizes that it does not have the intent “buy movie tickets” but it does understand the domain and concept of movie, and the action to “buy.” With this understanding, the personal assistant is able to access the appropriate knowledge-base and/or location within the knowledge-base.

Flowing to operation 320, the knowledge-base (in one embodiment as a graph) is accessed that generally matches the task to learn. According to an embodiment, a user-independent knowledge-base (e.g. such as FREEBASE, DBPEDIA, and the like) are accessed. Generally, a knowledge-base comprises structured data relating to different topics/entities that each have a unique identifier. For example, FREEBASE currently comprises almost 23 million entities. The data may be accessed through an Application Programming Interface (API) that may be used to perform searches/queries as well as write new data (e.g. add a new entity, extend a new entity, . . . ).

Transitioning to operation 330, the information to perform the task is learned from the user. The information may be learned through recording a user's actions to perform a task and/or through other modalities (e.g. speech, gestures, . . . ). One or more user interfaces may be displayed to receive actions and/or present information.

Moving to operation 340, the newly learned information (e.g. task) is stored. According to an embodiment, the knowledge-base (e.g. FREEBASE, DBPEDIA, and the like) is extended with knowledge obtained from the user that is interacting with the personal assistant. The graph is extended by adding new nodes and edges that connect these nodes to existing nodes. These extensions represent the new knowledge learned. The extensions to the knowledge-base can be learned implicitly or explicitly. According to an embodiment, hidden Markov models (HMMs) are used to represent task models, where each state of the HMM is an intent. Data from logs (e.g. search and browse logs such as queries, clicks, page views, dwell times, etc.) may be used to initialize the HMMs. When the individual user introduces a new task to the personal assistant that it has not seen and does not know how to perform, the personal assistant identifies this task from the large set of task models it has built from the data. This model is then used to generalize the new task the user is teaching the system by adapting it on the user's example data. According to an embodiment, lower level knowledge is represented by a connected graph, typically a weighted triple or quad store. The nodes of the graphs are entities (person, place, or thing). The edges of the graph are relations between the entities. Intent/Task graphs may be constructed by mapping lower level concept subgraphs to higher level intents/tasks (e.g., actions). In a simple case, a single concept graph node (entity) has an associated intent/action associated with it.

Flowing to operation 350, the knowledge-base is stored. The process then moves to an end operation and returns to processing other actions.

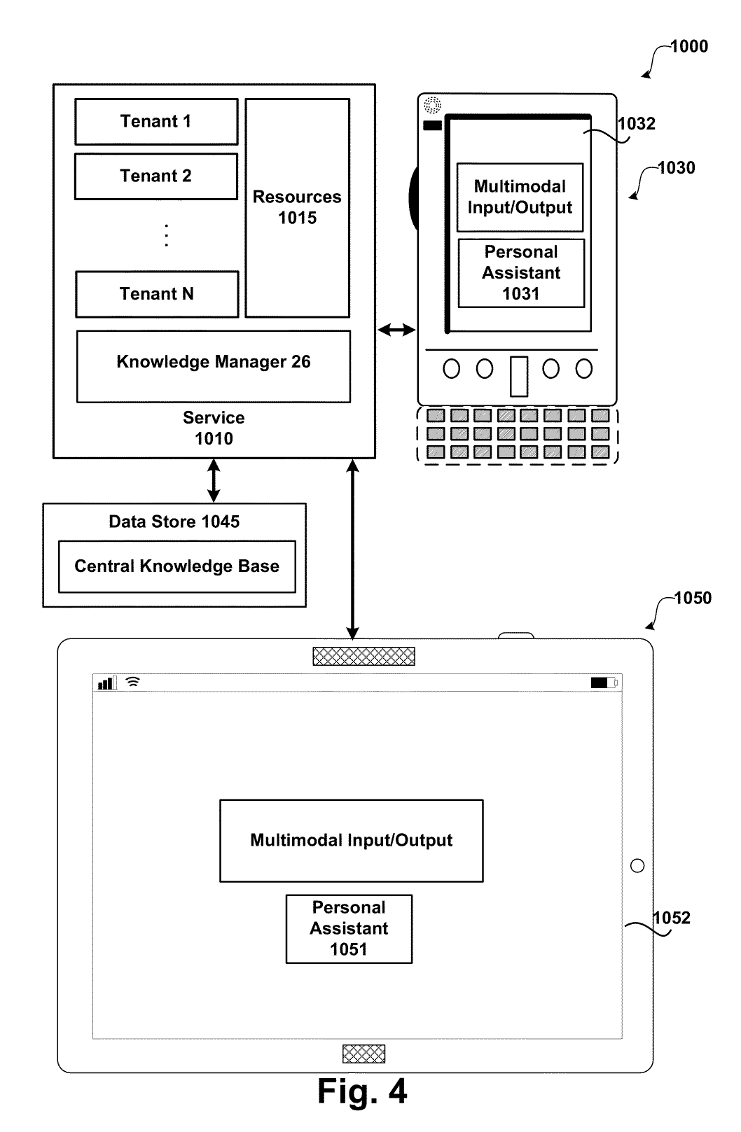

FIG. 4 illustrates an exemplary system for collaborative learning using information learned from different users and personal assistants in a multimodal system. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as multimodal services related to various applications (e.g. games, browsing, locating, productivity services (e.g. spreadsheets, documents, presentations, charts, messages, and the like)). The service may be interacted with using different types of input/output. For example, a user may use speech input, touch input, hardware based input, and the like. The service may provide speech output that combines pre-recorded speech and synthesized speech. Functionality of one or more of the services/applications provided by service 1010 may also be configured as a client/server based application. Although system 1000 shows a service relating to a multimodal application, other services/applications may be configured to use information learned from knowledge manager 26 and personal assistants (e.g. personal assistant 1031 and personal assistant 1051).

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with multimodal applications and each include a personal assistant (1031, 1051).

As illustrated, touch screen input device/display 1050 and smart phone 1030 shows exemplary displays 1052/1032 showing the use of an application including the user of personal assistants and using multimodal input/output. Data may be stored on a device (e.g. smart phone 1030, slate 1050 and/or at some other location (e.g. network data store 1045). Data store 1054 may be used to store the central knowledge base that includes information learned from each of the different personal assistants. The applications used by the devices may be client based applications, server based applications, cloud based applications and/or some combination.

Knowledge manager 26 is configured to perform operations relating to collaborative learning through personal assistants as described herein. While manager 26 is shown within service 1010, the functionality of the manager may be included in other locations (e.g. on smart phone 1030 and/or slate device 1050).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

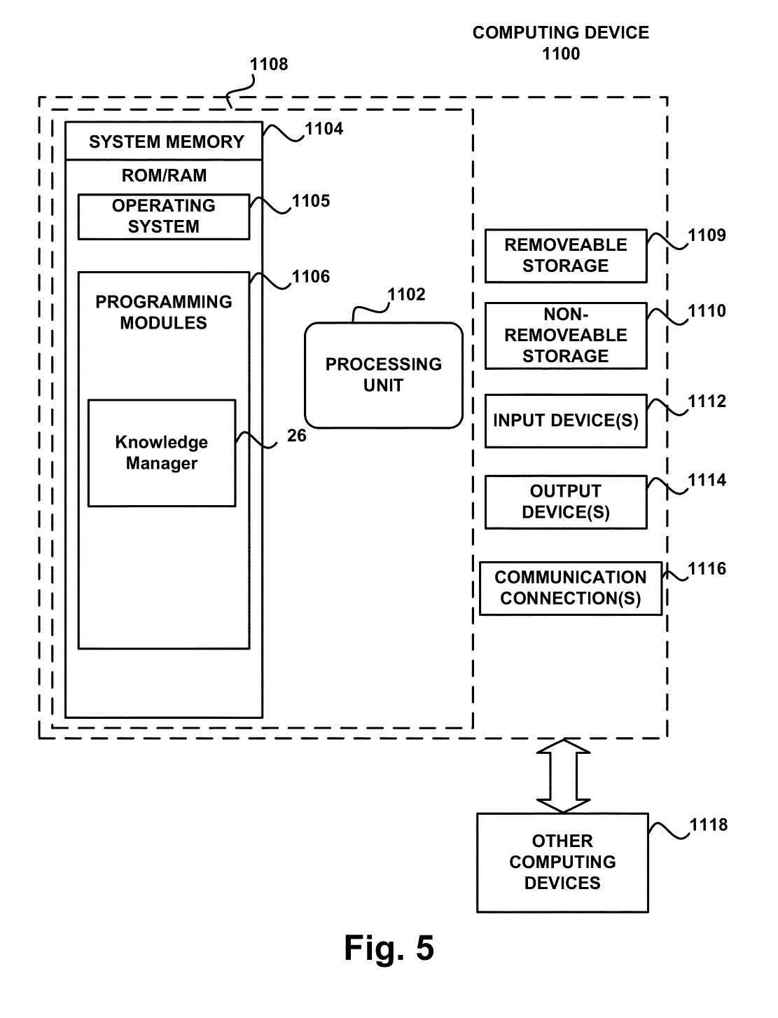

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a knowledge manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 5 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to methods as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

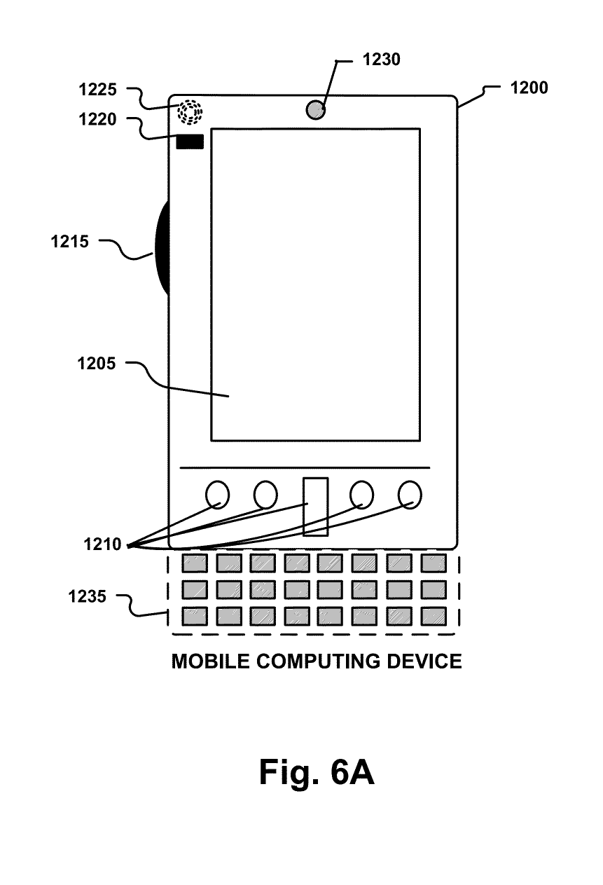

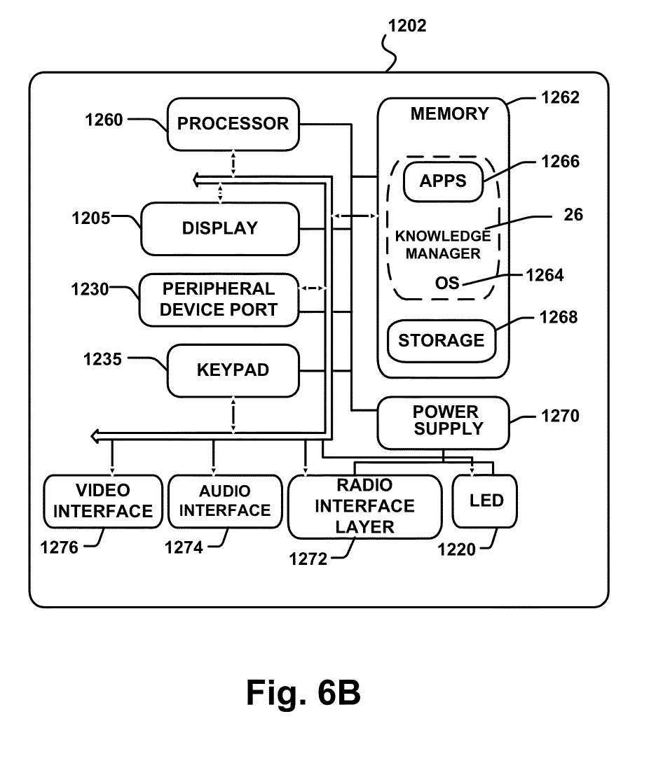

FIGS. 6A and 6B illustrate a suitable mobile computing environment, for example, a mobile telephone, a smartphone, a tablet personal computer, a laptop computer, and the like, with which embodiments of the invention may be practiced. With reference to FIG. 6A, an example mobile computing device 1200 for implementing the embodiments is illustrated. In a basic configuration, mobile computing device 1200 is a handheld computer having both input elements and output elements. Input elements may include touch screen display 1205 and input buttons 1215 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1215. Mobile computing device 1200 may also include an optional keypad 1235. Optional keypad 1215 may be a physical keypad or a “soft” keypad generated on the touch screen display.

Mobile computing device 1200 incorporates output elements, such as display 1205, which can display a graphical user interface (GUI). Other output elements include speaker 1225 and LED light 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 6B is a block diagram illustrating components of a mobile computing device used in one embodiment, such as the computing device shown in FIG. 6A. That is, mobile computing device 1200 can incorporate system 1202 to implement some embodiments. For example, system 1202 can be used in implementing a “smart phone” that can run one or more applications similar to those of a desktop or notebook computer such as, for example, presentation applications, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 1262 and run on or in association with operating system 1264. Examples of application programs include phone dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the knowledge manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone 1220 to receive audible input, such as to facilitate a telephone conversation. In accordance with embodiments of the present invention, the microphone 1220 may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 8B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

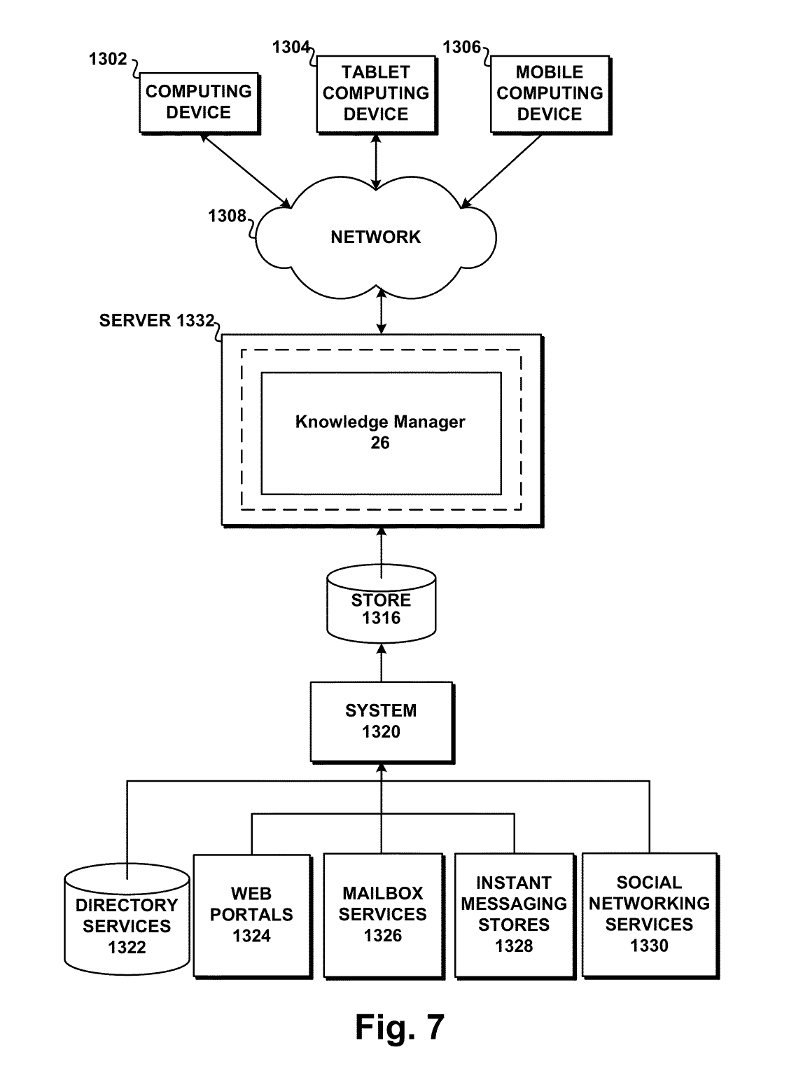

FIG. 7 illustrates a system architecture for collaborative learning using personal assistants.

Components managed via the knowledge manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to using and determining variations. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for collaborative learning using personal assistants, comprising:
receiving a user interaction at a personal assistant directed at performing a task;
determining when the personal assistant knows how to perform the task and when the personal assistant does not know how to perform the task, performing operations comprising:
learning instructions to perform the task using the personal assistant; and
sending the learned instructions to a knowledge manager that receives learned instructions from different personal assistants that are associated with different users and creates a collective user knowledge base comprising tasks that is shared with the personal assistants;
receiving information from the collective user knowledge base learned from interaction with personal assistants learned from other users.

2. The method of claim 1, wherein receiving the user interaction at the personal assistant directed at performing the task comprises receiving multimodal user input comprising speech input and at least one other form of input.

3. The method of claim 1, further comprising accessing a user-independent knowledge-base and extending the user-independent knowledge-base with the learned task.

4. The method of claim 1, wherein learning the instructions to perform the task using the personal assistant comprises creating a task model that is a graph that is constructed by mapping lower level concept sub graphs to higher level actions.

5. The method of claim 4, further comprising using at least one of: a pattern recognition classifier, a sequential pattern recognition classifier; and a hidden Markov model (HMM) to represent the task model

6. The method of claim 5, wherein the task model is initialized from search and browse logs comprising two or more of: queries, clicks, page views, and dwell times.

7. The method of claim 3, further comprising determining a generalization of the task and extending the knowledge-base based on example data learned from the user.

8. The method of claim 1, wherein nodes of the knowledge-base are entities comprising: a person, a place, and an item and edges of the knowledge-base are relations between the entities.

9. The method of claim 1, further comprising presenting a display to receive the instructions to perform the task from the user.

10. A computer-readable medium storing computer-executable instructions for collaborative learning using personal assistants, comprising:
receiving a user interaction at a personal assistant directed at performing a task;
determining when the personal assistant knows how to perform the task and when the personal assistant does not know how to perform the task, performing operations comprising:
learning instructions to perform the task using the personal assistant;
accessing a knowledge-base and extending the user-independent knowledge-base using the learned instructions to perform the task; and
sending the learned instructions to a knowledge manager that receives learned instructions from different personal assistants that are associated with different users and creates a collective user knowledge base comprising tasks that is shared with the personal assistants; and
receiving information from the collective user knowledge base learned from interaction with personal assistants learned from other users.

11. The computer-readable medium of claim 10, wherein receiving the user interaction at the personal assistant directed at performing the task comprises receiving multimodal user input comprising speech input and touch input.

12. The computer-readable medium of claim 10, wherein learning the instructions to perform the task using the personal assistant comprises creating a task model that is a graph that is constructed by mapping lower level concept sub graphs to higher level actions.

13. The computer-readable medium of claim 12, further comprising using a hidden Markov models (HMM) to represent the task model, where each state of the HMM is an intent.

14. The computer-readable medium of claim 13, wherein the task model is initialized from search and browse logs comprising two or more of: queries, clicks, page views, and dwell times.

15. The computer-readable medium of claim 10, further comprising determining a generalization of the task and extending the knowledge-base based on example data learned from the user.

16. The computer-readable medium of claim 10, wherein nodes of the knowledge-base are entities comprising: a person, a place, and an item and edges of the knowledge-base are relations between the entities.

17. A system for collaborative learning using personal assistants, comprising:
a processor and memory;
an operating environment executing using the processor;
a display; and
a knowledge manager that is configured to perform actions comprising:
receiving a user interaction at a personal assistant directed at performing a task;
determining when the personal assistant knows how to perform the task and when the personal assistant does not know how to perform the task, performing operations comprising:
learning instructions to perform the task using the personal assistant;
accessing a knowledge-base based on a determined generalization of the task and extending the user-independent knowledge-base using the learned instructions to perform the task; and
sending the learned instructions to a knowledge manager that receives learned instructions from different personal assistants that are associated with different users and creates a collective user knowledge base comprising tasks that is shared with the personal assistants; and
receiving information from the collective user knowledge base learned from interaction with personal assistants learned from other users.

18. The system of claim 17, wherein receiving the user interaction at the personal assistant directed at performing the task comprises receiving multimodal user input comprising speech input and touch input.

19. The system of claim 17, wherein learning the instructions to perform the task using the personal assistant comprises creating a task model that is a graph that is constructed by mapping lower level concept sub graphs to higher level actions.

20. The system of claim 19, further comprising initializing the task model from search and browse logs comprising two or more of: queries, clicks, page views, and dwell times.
